(19) United States
(12) Patent Application Publication
(10) Pub. No.: US 2022/0221583 A1
(43) Pub. Date: Jul. 14, 2022

(54) ULTRA-LOW PHASE NOISE MILLIMETER-WAVE OSCILLATOR AND METHODS TO CHARACTERIZE SAME

(71) Applicant: IMRA AMERICA, INC., Ann Arbor, MI (US)

(72) Inventors: Antoine Jean Gilbert Rolland, Longmont, CO (US); Eng Hiang Mark Yeo, Lakewood, CO (US); Tomohiro Tetsumoto, Longmont, CO (US)

(21) Appl. No.: 17/224,938

(22) Filed: Apr. 7, 2021

Related U.S. Application Data
(60) Provisional application No. 63/009,291, filed on Apr. 13, 2020.

(51) Int. Cl. G01S 17/34; G01S 7/493; G01S 7/4912; H04B 10/64; H04B 10/40; H04B 10/2581; H04B 10/27

(52) U.S. Cl. CPC G01S 17/34; G01S 7/493; G01S 7/4917; H04B 10/271; H04B 10/40; H04B 10/2581; H04B 10/64

(57) ABSTRACT

A tunable millimeter-wave signal oscillator includes two phase coherent optical oscillators, a fiber-ring cavity configured to generate two Stokes waves, and a photosensitive element converting the frequency difference of two optical oscillator into a millimeter-wave radiation. A chip-scale form factor millimeter-wave oscillator includes two continuous wave lasers, a plurality of micro-optical-resonators, an optical frequency division mechanism, two optical tunable bandpass filters, and a photosensitive element converting the pulse train of a frequency comb into a millimeter-wave radiation. A millimeter-wave phase noise analyzer includes an optical interferometer, two photosensitive elements, and a fundamental millimeter-wave frequency mixer. A millimeter-wave frequency counter includes an electro-optic optical frequency comb generator, a microwave voltage controlled oscillator, and an optoelectronic phase locked loop. A millimeter-wave electrical spectrum analyzer includes a millimeter-wave phase noise analyzer, a millimeter-wave amplitude detector, a millimeter-wave frequency counter, and a data processing unit.

### CLAIM OF PRIORITY

The present application claims the benefit of priority to U.S. Provisional Appl. No. 63/009,291, filed Apr. 13, 2020, which is incorporated in its entirety by reference herein.

### BACKGROUND

### Field

The present application relates generally to tunable millimeter-wave oscillators in a frequency range of about 300 GHz to about 1 THz, and more specifically, to chip-scale implementations and methods of characterization of the long-term stability of the phase noise power spectral density for use in microwave clocks.

### Description of the Related Art

Many studies have suggested various approaches in order to implement millimeter-wave oscillators. For example, the most common technology of direct generation relies on Gunn diode oscillators. A Gunn diode oscillator is an oscillator built around a Gunn diode which is a type of diode that uses two negatively doped regions with a slightly less negatively doped region between the two negatively doped regions. This diode configuration provides a negative resistance over a certain threshold voltage, and behaves as a transferred electron device. With a negative resistance, instability and oscillations can readily occur. Gunn diodes can be fabricated using semiconductor materials with very high electron mobility and frequency response, and terahertz oscillators have been built using this technology. For example, gallium arsenide and gallium nitride semiconductor materials are commonly used to make Gunn diodes that operate in the gigahertz to terahertz frequency range. Gunn diode oscillators are known for being able to produce extremely high energy levels at high frequencies, and they are commonly used in microwave, millimeter-wave, and terahertz systems.

Microwave multiplication is another example approach to implement millimeter-wave oscillators, in which the frequency of a microwave oscillator is multiplied, emitting a signal having a frequency up to about 10 GHz. Generally, based on step recovery diodes and electrical comb generators, the microwave signal can be amplified at high power and can saturate the diode to generate an electrical comb with frequencies up to the millimeter-wave range. However, the phase noise of the microwave oscillator is also multiplied and therefore experiences a phase noise increase by 20×log(N), with N being the frequency multiplication order.

Another example approach to implement millimeter-wave oscillators is photomixing (also known as optical rectification), in which a non-linear optical medium is impinged with light (e.g., using photodiodes and/or photoconductors), the light having at least two optical frequencies that are separated from one another by the desired millimeter-wave frequency (e.g., up to a few THz; 5 THz). However, to generate spectrally pure and stable signals (e.g., comparable to those obtained using the other two example approaches), the phase noise of the two optical lines is desirably strongly correlated. While the laser line noise need not be low, it is sufficient if the common noise on the two optical lines is fractionally of the same in order to cancel out to the first order at the photodetector. Uni-travelling photodiodes are convenient to use in the sense that they can emit THz waves up to 2 THz using light at 1550 nm. One drawback of this photomixing approach is the low emitted power, as opposed to photoconductors that can directly generate a few mW (e.g., for light at 800 nm).

### SUMMARY

Certain embodiments described herein provide a method of generating millimeter-wave optical signals. The method comprises phase locking two frequency components of a bichromatic pump source. The method further comprises inputting the two frequency components into a fiber-ring cavity and generating a bichromatic output from the fiber-ring cavity. The method further comprises photomixing the bichromatic output of the fiber-ring cavity.

Certain embodiments described herein provide a phase noise analyzer configured to measure phase noise of millimeter-wave radiation. The phase noise analyzer comprises an optical interferometer comprising a first arm and a second arm. The first arm is configured to propagate two first optical signals separated in frequency from one another by a millimeter wave frequency. The second arm is configured to propagate two second optical signals separated in frequency from one another by a sum or a difference of the millimeter wave frequency and a radio frequency. The phase noise analyzer further comprises an optical path configured to propagate a delayed heterodyne signal indicative of a frequency difference of the two first optical signals and the two second optical signals.

Certain embodiments described herein provide a phase noise analyzer configured to measure phase noise of millimeter-wave radiation. The phase noise analyzer comprises an optical frequency modulator configured to be driven by the millimeter wave radiation, to receive a continuous wave laser signal, and to generate optical sidebands on the continuous wave laser signal. The optical sidebands are spaced from the continuous wave laser signal by a spacing equal to the millimeter wave radiation. The phase noise analyzer further comprises an optical delay line. The phase noise analyzer further comprises a photoconductive element and a mixer configured to derive a homodyne beat between a frequency difference between the optical sidebands and the millimeter wave radiation.

Certain embodiments described herein provide a dual mode spectrum analyzer configured to analyze millimeter-wave radiation phase noise. The dual mode spectrum analyzer comprises an optical switch configured to select an optical input from either bichromatic radiation or CW laser radiation that is modulated at a millimeter wave frequency of the millimeter wave radiation. The dual mode spectrum analyzer further comprises a phase noise analyzer comprising an optical interferometer comprising a first arm and a second arm. The first arm is configured to propagate two first optical signals separated in frequency from one another by a millimeter wave frequency. The second arm is configured to propagate two second optical signals separated in frequency from one another by a sum or a difference of the millimeter wave frequency and a radio frequency. The phase noise analyzer further comprises an optical path configured to propagate a delayed heterodyne signal indicative of a frequency difference of the two first optical signals and the two second optical signals. The dual mode spectrum analyzer further comprises a frequency detector, a photosensitive element configured to photomix the bichromatic radiation, a millimeter-wave power detector, and a millimeter-wave voltage detector.

Certain embodiments described herein provide a dual mode spectrum analyzer configured to analyze millimeter-wave radiation phase noise. The dual mode spectrum analyzer comprises an optical frequency modulator configured to be driven by the millimeter wave radiation, to receive a continuous wave laser signal, and to generate optical sidebands on the continuous wave laser signal. The optical sidebands are spaced from the continuous wave laser signal by a spacing equal to the millimeter wave radiation. The phase noise analyzer further comprises an optical delay line. The phase noise analyzer further comprises a photoconductive element and a mixer configured to derive a homodyne beat between a frequency difference between the optical sidebands and the millimeter wave radiation. The dual mode spectrum analyzer further comprises a frequency detector, a photosensitive element configured to photomix the bichromatic radiation, a millimeter-wave power detector, and a millimeter-wave voltage detector.

Certain embodiments described herein provide a method for real-time frequency counting millimeter-wave frequencies and Terahertz frequencies generated from photomixing of two optical frequencies. The method comprises generating spatially overlapped interleaving electro-optic combs from each of the two optical frequencies using frequency and amplitude modulators. The method further comprises optical and electronic filtering of the two interleaved combs to isolate the lowest difference frequency between the two interleaved combs at an electronically countable radio frequency.

Certain embodiments described herein provide a chip-scale millimeter-wave source with reduced phase noise. The source comprises a photonic integrated frequency comb having a repetition frequency or a multiple of the repetition frequency that is tunable to the millimeter wave frequency. The source further comprises means for phase locking two comb teeth to two optical frequencies by adjusting the repetition frequency and carrier offset frequencies of the frequency comb. The source further comprises means for reducing phase noise of the resulting millimeter wave relative to a phase noise of the two optical frequencies.

Certain embodiments described herein provide a millimeter-wave signal generator that comprises two phase locked continuous-wave lasers with a frequency difference of a few hundreds of GHz; a gain element comprising a fiber-ring cavity with stimulated Brillouin scattering; two optical phase locked loops configured to eliminate mode-hopping of the fiber-ring cavity; a photosensitive element configured to receive two optical lines with a frequency separation and to produce a millimeter-wave signal having a frequency equal to the frequency difference between the two optical lines guided or radiated through a millimeter-wave antenna.

Certain embodiments described herein provide a millimeter-wave phase noise analyzer that comprises an interferometer based on a fiber optic delay line and an acousto-optic modulator based on an optically-produced millimeter-wave frequency shifter; two photosensitive elements configured to receive two optical lines with a frequency separation and to produce a millimeter-wave signal having a frequency equal to the frequency difference between the two optical lines guided or radiated through a millimeter-wave antenna; a millimeter-wave fundamental frequency mixer configured to produce an intermediate frequency in the RF domain from two millimeter-wave signals having a non-zero frequency difference.

Certain embodiments described herein provide a millimeter-wave phase noise analyzer that comprises a interferometer based on a fiber optic delay line and an acousto-optic modulator based on an optically-produced millimeter-wave frequency shifter; one single photosensitive element configured to receive two optical lines having a frequency separation and to produce a millimeter-wave signal having a frequency equal to the frequency difference between the two optical lines guided or radiated through a millimeter-wave antenna; a millimeter-wave amplitude detector.

Certain embodiments described herein provide a millimeter-wave frequency counter that comprises a microwave voltage control oscillator diving cascaded electro-optic phase and/or amplitude modulator; an optical bandpass filter; and a optoelectronic phase locked loop.

Certain embodiments described herein provide a phase locking architecture for stability transfer of a microwave source to a fiber-ring cavity that comprises a continuous-wave pump laser; an acousto-optic based optical interferometer; a fiber-ring cavity; a photosensitive element configured to produce a heterodyne signal carrying the stability of the fiber-ring-cavity; and a phase locked loop.

Certain embodiments described herein provide a millimeter-wave electrical spectrum analyzer that comprises a millimeter-wave frequency counter, a millimeter-wave amplitude detector, a millimeter-wave power meter, a millimeter-wave phase noise analyzer, and a data processing unit.

Certain embodiments described herein provide a chip-scale implementation of a millimeter-wave oscillator that comprises two continuous-wave lasers, one high quality factor (high Q) microresonator configured to be an optical reference for stabilization of continuous-wave lasers, two Pound-Drever-Hall (PDH) locking schemes, one combination optical modulator, one microresonator-based optical frequency comb with high repetition rate (e.g., a few hundreds of GHz), and a photosensitive element configured to convert an optical pulse train into a millimeter-wave signal.

Certain embodiments described herein provide a mechanism for optical linewidth reduction of a microresonator-based Soliton optical frequency comb, a Kerr optical frequency comb, or a modulation instability optical frequency comb. A pump laser frequency noise is compensated using a self-heterodyne interferometer.

Certain embodiments described herein provide a physical mechanism configured to stabilize the comb modes of an optical frequency microcomb to the resonances of a microresonator exploited in cold conditions at very low optical power overcoming the thermal noise induced by high power in resonators in order to generate optical frequency microcombs.

Certain embodiments described herein provide a micro-resonator operating in a soliton regime to generate a millimeter-wave signal by photodetecting the repetition rate of the micro-resonator. The repetition rate is stabilized to a dielectric resonant oscillator through an optoelectronic down-conversion scheme based on photodetection between the interleaving of two electro-optic frequency combs generated from two optical lines from a soliton microcomb.

Certain embodiments described herein provide a mechanism of optical linewidth reduction (e.g., frequency noise reduction) of continuous-wave lasers through stimulated Brillouin scattering in a high-Q lithium niobate (LN) optical resonator. The resonator is based on a rib waveguide or a stripe waveguide with silica or air upper and bottom clad.

The foregoing summary and the following drawings and detailed description are intended to illustrate non-limiting examples but not to limit the disclosure.

### BRIEF DESCRIPTION OF THE DRAWINGS

FIG. 1 schematically illustrates coherent pumping of a Brillouin fiber-ring cavity and millimeter-wave signal generation of two Stokes waves in accordance with certain embodiments described herein.

FIG. 2A schematically illustrates an example millimeter-wave oscillator based on the coherent pumping of a fiber-ring cavity and the mode-hopping suppression associated with it for the single mode oscillation of two Stokes waves impinging a photosensitive element in accordance with certain embodiments described herein.

FIG. 2B is a plot of the measured power spectral density (PSD) of the phase noise (dBc/Hz) versus Fourier frequency (Hz) of an example millimeter-wave oscillator of FIG. 2A (labeled “IMRA Brillouin (2019)”) in accordance with certain embodiments described herein, compared to the PSD of previously-disclosed millimeter-wave oscillators.

FIG. 2C is a plot of the fractional frequency instability versus averaging time (s) of an example millimeter-wave oscillator of FIG. 2A (labeled “IMRA Brillouin (300 GHz)”) in accordance with certain embodiments described herein, compared to that of previously-disclosed compact millimeter-wave oscillators operating at standard temperature and pressure.

FIG. 3A schematically illustrates an example millimeter-wave oscillator based on electro-optic multiplication of a microwave source spectrally purified by a Brillouin-based fiber-ring cavity generating two Stokes waves impinging a photosensitive element in accordance with certain embodiments described herein.

FIG. 3B is a plot of the optical power (dB) versus wavelength (nm) of the electro-optic frequency comb generated by the example millimeter-wave oscillator of FIG. 3A, before and after spectral filtering and amplification, in accordance with certain embodiments described herein.

FIG. 4A schematically illustrates an example configuration for the stabilization (e.g., phase lock) of a fiber-ring cavity to a microwave reference in accordance with certain embodiments described herein.

FIG. 4B is a plot of the power spectral density (PSD) of the phase noise (dBc/Hz) versus Fourier frequency (Hz) of an example millimeter-wave oscillator without phase locking (labeled “IMRA 2019”) in accordance with certain embodiments described herein, and with phase locking of the Brillouin oscillator to a rubidium (Rb) clock (labeled “Locked to Rb clock”) in accordance with certain embodiments described herein.

FIG. 5A schematically illustrates an example configuration for the stabilization of a fiber-ring cavity to a microwave reference and polarization handling for implementing a single frequency laser generator in accordance with certain embodiments described herein.

FIG. 5B is a plot of the power spectral density (PSD) of the phase noise (dBc/Hz) versus Fourier frequency (Hz) of the example configuration of FIG. 5A operated as a single out-of-loop continuous wave laser used in accordance with certain embodiments described herein.

FIG. 6A schematically illustrates an example millimeter-wave phase noise analyzer based on a self-heterodyne interferometer and a down-conversion mechanism based on a photosensitive element coupled to a millimeter-wave amplitude detector in accordance with certain embodiments described herein.

FIG. 6B is a plot of the power spectral density (PSD) of the millimeter-wave phase noise (dBc/Hz) versus Fourier frequency (Hz) measured at 300 GHz using the example millimeter-wave phase noise analyzer of FIG. 6A.

FIG. 7A schematically illustrates an example millimeter-wave phase noise analyzer based on a self-heterodyne interferometer and a down-conversion mechanism based on two photosensitive elements coupled to a millimeter-wave fundamental frequency mixer in accordance with certain embodiments described herein.

FIG. 7B is a plot of the power spectral density (PSD) of the millimeter-wave phase noise (dBc/Hz) versus Fourier frequency (Hz) measured at 300 GHz using the example millimeter-wave phase noise analyzer of FIG. 7A.

FIG. 8 schematically illustrates an example millimeter-wave phase noise analyzer based on a millimeter-wave-to-optical converter, a self-heterodyne interferometer, and a down-conversion mechanism based on two photosensitive elements coupled to a millimeter-wave fundamental frequency mixer in accordance with certain embodiments described herein.

FIG. 9 schematically illustrates an example millimeter-wave phase noise analyzer based on a millimeter-wave-to-optical converter, a self-homodyne interferometer, and a down-conversion mechanism based on one photosensitive element coupled to a millimeter-wave fundamental frequency mixer in accordance with certain embodiments described herein.

FIG. 10 schematically illustrates an example millimeter-wave phase noise analyzer based on a self-homodyne interferometer and a down-conversion mechanism based on one photosensitive element coupled to a millimeter-wave heterodyne detector in accordance with certain embodiments described herein.

FIG. 11A schematically illustrates an example millimeter-wave frequency counter based on an electro-optic down conversion of the frequency difference of two optical wavelengths in accordance with certain embodiments described herein.

FIG. 11B is a plot of the millimeter-wave frequency (GHz) versus time (ms) of an example frequency counted millimeter-wave oscillator in accordance with certain embodiments described herein.

FIG. 11C is a plot of the relative power (dB) versus relative frequency (kHz) of the phase locking for internal counting of an example millimeter-wave oscillator in accordance with certain embodiments described herein.

FIG. 11D is a plot of the fractional frequency instability versus averaging time (s) exhibiting the sensitivity and resolution of the example millimeter-wave frequency counter of FIG. 11A.

FIG. 12 schematically illustrates an example ultra-high sensitivity and resolution millimeter-wave electrical spectrum analyzer in accordance with certain embodiments described herein.

FIG. 13 schematically illustrates an example chip-scale implementation of an ultra-low noise millimeter-wave oscillator based on the optical frequency division of the frequency difference of two continuous wave lasers down to a millimeter-wave signal through an optical frequency microcomb having a pulse train that impinges a photosensitive element in accordance with certain embodiments described herein.

FIG. 14A schematically illustrates an example chip-scale implementation of noise reduction of an optical frequency microcomb based on the noise compensation of the pump laser in accordance with certain embodiments described herein.

FIG. 14B is a plot of the frequency noise (Hz²/Hz) versus offset frequency (Hz) of the in-loop signal for the example implementation of FIG. 14A when the compensation setup is on and off in accordance with certain embodiments described herein.

FIG. 14C is a plot of the frequency noise (Hz²/Hz) versus offset frequency (Hz) of the out-of-loop signal for the example implementation of FIG. 14A when the compensation setup is on and off in accordance with certain embodiments described herein.

FIG. 14D is a plot of the frequency noise (Hz²/Hz) versus frequency (THz) of the out-of-loop signal for the example implementation of FIG. 14A when the compensation setup is on for several mode number of the optical frequency microcomb in accordance with certain embodiments described herein.

FIG. 15A schematically illustrates an example chip-scale implementation of noise reduction of an optical frequency microcomb based on the noise compensation of the pump laser through an internal self-heterodyne interferometer in accordance with certain embodiments described herein.

FIG. 15B schematically illustrates an example chip-scale implementation of noise reduction of an optical frequency microcomb based on the noise compensation of the pump laser through an external self-heterodyne interferometer in accordance with certain embodiments described herein.

FIG. 16 schematically illustrates an example chip-scale implementation of noise reduction of an optical frequency microcomb based on the stabilization of one microcomb mode to the resonance of a cold microresonator in accordance with certain embodiments described herein.

FIG. 17 schematically illustrates an example chip-scale implementation of noise reduction of an optical frequency microcomb based on the stabilization of two microcomb modes to the resonances of a cold microresonator in accordance with certain embodiments described herein.

FIG. 18A schematically illustrates an example millimeter-wave oscillator (e.g., chip-scale) using an example stabilization scheme to faithfully transfer the spectral purity of a dielectric resonant oscillator to the repetition rate of a micro-resonator in a soliton regime in accordance with certain embodiments described herein.

FIG. 18B is a plot of the measured power spectral density (PSD) of the phase noise (dBc/Hz) versus Fourier frequency (Hz) of the example millimeter-wave oscillator of FIG. 18A generated with a microcomb at 300 GHz in accordance with certain embodiments described herein.

FIG. 19A schematically illustrates an example on-chip Brillouin laser based on a LN optical resonator in accordance with certain embodiments described herein.

FIG. 19B schematically illustrates a cross section of an example LN rib waveguide structure for the Brillouin lasing of FIG. 19A in accordance with certain embodiments described herein.

FIG. 19C depicts example simulated optical modes (upper portion of FIG. 19C) and acoustic modes (bottom portion of FIG. 19C) of an example LN waveguide with a cross section schematically illustrated in FIG. 19B in accordance with certain embodiments described herein.

FIG. 19D is a plot of the Brillouin shift frequency versus calculated Brillouin gain in an example x-cut LN waveguide in accordance with certain embodiments described herein.

The figures depict various embodiments of the present disclosure for purposes of illustration and are not intended to be limiting. Wherever practicable, similar or like reference numbers or reference labels may be used in the figures and may indicate similar or like functionality.

### DETAILED DESCRIPTION

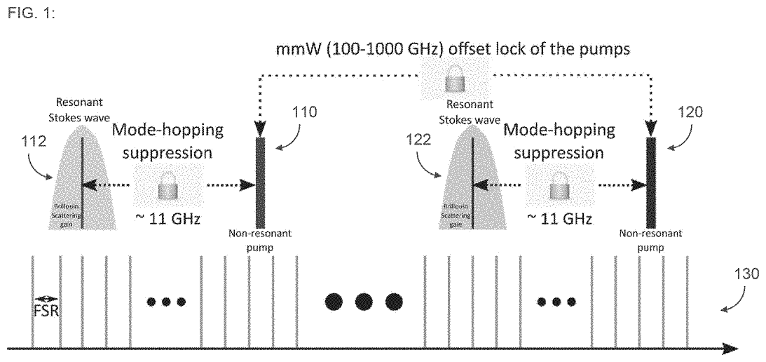

FIG. 1 schematically illustrates coherent pumping of a fiber-ring cavity (e.g., Brillouin fiber-ring cavity) and millimeter-wave signal generation of two Stokes waves in accordance with certain embodiments described herein. For example, a pump source (e.g., bichromatic pump source) can be configured to generate a first non-resonant pump signal 110 having a first frequency and a second non-resonant pump signal 120 having a second frequency different from the first frequency (e.g., separated from the first frequency by a few hundreds of GHz). An electro-optic comb 130, acting as a down-converter, comprising a plurality of comb lines spaced from one another by a free spectral range (FSR) can be used to offset lock the first and second pump signals 110, 120 to a microwave signal having a frequency less than 1 GHz. A fiber-ring cavity (not shown) can be configured to receive the two phase coherent pump signals 110, 120 which are not resonant with the fiber-ring cavity but are configured to generate corresponding Brillouin scattering gain signals 112, 122 which are spectrally separated from the corresponding phase coherent pump signal 110, 120 (e.g., by about 11 GHz). Two Stokes waves 112, 122 can resonate within the fiber-ring cavity, the two Stokes waves 112, 122 spectrally separated from one another (e.g., by the same amount as the two pump signals 110, 120 are separated from one another).

In certain embodiments, the fiber-ring cavity is sufficiently long such that the quality factor is greater than 10⁶. In certain embodiments, the length of the fiber-ring cavity is sufficiently long such that the optical power of a pump wave which is not resonant with the fiber-ring cavity and which generates Brillouin scattering within the fiber-ring cavity is sufficiently low to avoid degenerate four-wave mixing (e.g., the optical power is less than 300 mW). In certain embodiments, the length of the fiber-ring cavity is sufficiently short such that the free spectral range of the fiber-ring cavity is greater than 1 MHz. For example, the optical fiber of the fiber-ring cavity can have a length in a range of 50 meters to 150 meters. Additionally, phase noise of the Stokes waves 112, 122 can be strongly reduced under the combined influence of the acoustic damping and the cavity feedback. There is no population inversion in the Brillouin lasing process, and spontaneous scattering, not spontaneous emission, limits the degree of monochromaticity of the Stokes radiation. For mono-mode oscillation of the Stokes wave, certain embodiments comprise an additional phase-locked loop (PLL) configured to force the fiber-ring cavity to oscillate on only one mode of the fiber-ring cavity. The frequency difference (corresponding to the so-called Brillouin shift) between the Stokes wave and its respective pump signal is phase locked to a microwave oscillator having a frequency that is equal to the Brillouin shift. In certain embodiments, an error signal is applied to a frequency modulation of the pump source (e.g., by modulating the laser current or by using an external acousto-optic modulator) through a proportional-integral-derivative (PID) controller.

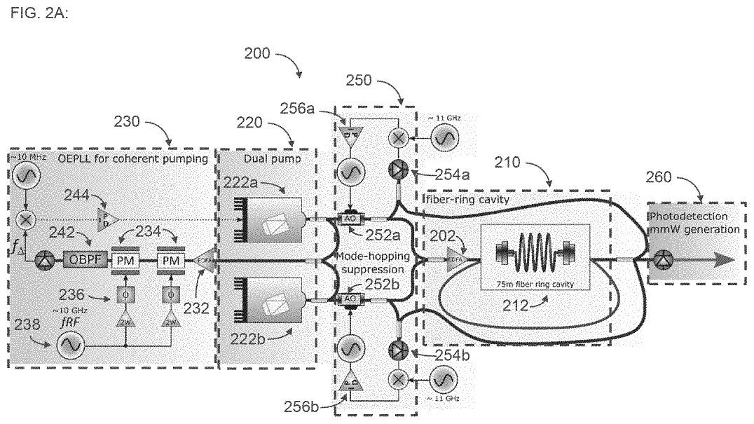

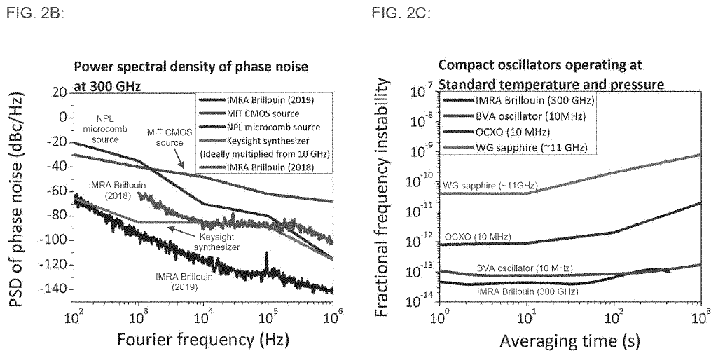

FIG. 2A schematically illustrates an example millimeter-wave oscillator 200 based on the coherent pumping of a fiber-ring cavity 210 and the mode-hopping suppression associated with it for the single mode oscillation of two Stokes waves impinging a photosensitive element in accordance with certain embodiments described herein. In certain embodiments, the example millimeter-wave oscillator 200 comprises a fiber amplifier 202 (e.g., an erbium doped fiber amplifier (EDFA)) and a fiber-ring cavity 210 (labeled “fiber-ring cavity”) comprising a polarization maintaining fiber 212 (e.g., with a length of 75 m) configured to have the stimulated Brillouin scattering therein. While the pump lasers are not resonant to the fiber-ring cavity 210, the backscattered light (e.g., Stokes wave) is resonant to the fiber-ring cavity 210 such that light is always present at the output regardless of the operating condition of the millimeter-wave oscillator 200.

In certain embodiments, as schematically illustrated by FIG. 2A, the example millimeter-wave oscillator 200 comprises a dual pump source 220 (labeled “Dual pump”). In certain embodiments in which the dual pump source 220 is based on a fixed fashion, the dual pump source 220 can comprise two phase coherent continuous wave (CW) lasers 222a,b (e.g., available from Redfern Integrated Optics of Santa Clara, Calif.), as schematically illustrated by FIG. 2A, the two lasers 222a,b separated in frequency from one another (e.g., by 300 GHz). In certain other embodiments, the dual pump source 220 can comprise one wavelength-fixed laser and one tunable laser. In certain embodiments, the output of the two lasers 222a,b of the dual pump source 220 are combined together with a fiber coupler.

In certain embodiments, as schematically illustrated by FIG. 2A, the example millimeter-wave oscillator 200 further comprises an optoelectronic phase locked loop 230 (labeled “OEPLL for coherent pumping”) comprising a fiber amplifier 232 (e.g., erbium doped fiber amplifier (EDFA)) configured to receive a portion of the output from the dual pump source, two cascaded optical phase modulators (PM) 234 controlled by a corresponding pair of phase shifters (ϕ) 236 and a dielectric-resonant oscillator (DRO) 238 (e.g., at around 10 GHz), the two phase modulators 234 configured to receive the output from the fiber amplifier 232, an optical bandpass filter (OBPF) 242 configured to receive the phase modulated output from the phase modulators 234, and a proportional-integral-derivative controller (PID) 244 configured to receive the filtered signal and providing a signal to the dual pump source 220. In certain embodiments, the pump signals generate a Stokes wave that oscillates through the OEPLL 230, as showed in FIG. 2A. In certain embodiments in which the noise of the two lasers 222a,b of the dual laser source 220 is to be correlated, the optoelectronic phase lock loop 230 is configured to use down conversion to correlate the noise of the two pump lasers 222a,b within the feedback bandwidth of the OEPLL 230 (see, e.g., A. Rolland, G. Loas, M. Brunel, L. Frein, M Vallet, and M. Alouini, “Non-linear optoelectronic phase-locked loop for stabilization of opto-millimeter waves: towards a narrow linewidth tunable THz source,” Optics Express, 19, 17944-17950 (2012)).

In certain embodiments, as schematically illustrated by FIG. 2A, the example millimeter-wave oscillator 200 further comprises a mode-hopping suppression optical circuit 250 (labeled “Mode-hopping suppression”) configured to suppress mode-hopping resulting from the length of the fiber-ring cavity 210. In certain embodiments, the mode-hopping suppression optical circuit 250 comprises a pair of acousto-optic (AO) modulators 252a,b, each configured to receive a portion of the output signals from a respective laser of the dual pump source 220 and to provide an output signal to the fiber-ring cavity 210. The mode-hopping suppression circuit frequency mixes a pickoff of the frequency shifted optical output of the AO modulators 252a,b with a pickoff from the optical output of the fiber-ring cavity 210 on the photodiode 254a,b. The frequency difference between the optical output of the AO modulators 252a,b and its generated Brillouin radiation can span a value of f_{B}±FSR, where f_{B} is the Brillouin shift and FSR is the free spectral range of the fiber-ring cavity 210. When the frequency difference approaches either f_{B}+FSR or f_{B}−FSR, the Brillouin output tends to modehop, conversely, if the frequency difference is close to f_{B}, the Brillouin output does not modehop. Therefore, the optical frequency difference is locked to an external rf frequency source corresponding to f_{B} using the PID circuitry 256a,b which in turn adjusts the frequency shift induced by the AO modulators 252a,b to maintain the desired frequency difference.

In certain embodiments, as schematically illustrated by FIG. 2A, the example millimeter-wave oscillator 200 further comprises a photodiode 260 (e.g., UTC-photodiode) (labeled “Photodetection mmW generation”) that is configured to down-convert the two Stokes waves 112, 122 (e.g., tunable from 250-400 GHz) to the millimeter-wave domain. The photodiode 260 is configured to emit the down-converted signals to a waveguide (e.g., without any antenna to radiate the down-converted signals in free space).

FIG. 2B is a plot of the measured power spectral density (PSD) of the phase noise (dBc/Hz) versus Fourier frequency (Hz) of the example millimeter-wave oscillator of FIG. 2A (labeled “IMRA Brillouin (2019)”) in accordance with certain embodiments described herein. The measured PSD of the phase noise is −65 dBc/Hz at 100 Hz Fourier frequency and goes down to −140 dBc/Hz at 1 MHz. FIG. 2B also shows the PSD of the phase noise reported for various other millimeter-wave oscillators previously disclosed by: U.S. Pat. Appl. Publ. No. 2019/0235445A1 (labeled “MIT CMOS source”); doi.org/10.1364/OE.27.035257 (labeled “NPL microcomb source”); N5194A UXG X-Series Agile Vector Adapter (labeled “Keysight synthesizer”); doi.org/10.1364/OL.44.000359 (labeled “IMRA Brillouin (2018)”). FIG. 2B shows that the measures PSD of the phase noise of the example millimeter-wave oscillator of FIG. 2A is nearly four orders of magnitude lower than that of the previously-disclosed millimeter-wave oscillators.

FIG. 2C is a plot of the fractional frequency instability versus averaging time (s) of the example millimeter-wave oscillator of FIG. 2A (labeled “IMRA Brillouin (300 GHz)”) in accordance with certain embodiments described herein. Under a rough vacuum in an acrylic chamber, the example millimeter-wave oscillator of FIG. 2A at 300 GHz reaches 6×10⁻¹⁴ at 1 second averaging time and, due to drifts, averages to about 1×10⁻¹³ at higher averaging times. FIG. 2C also shows the fractional frequency instability reported for various other millimeter-wave oscillators (operating at standard temperature and pressure): OSA-8607 Boîtier à Vieillissement Amélioré (BVA) oscillator available from Brandywine Communications of Tustin Calif. (labeled “BVA oscillator”); HF-ULN oven-controlled crystal oscillator available from Wenzel Associates, Inc. of Austin Tex. (labeled “OCXO”); whispering gallery (WG) oscillator disclosed by doi.org/10.1063/1.2039387 (labeled “WG sapphire”). FIG. 2C shows that the level of instability of the example millimeter-wave oscillator of FIG. 2A is competitive with the instabilities of other compact oscillators performing at standard temperature and pressure.

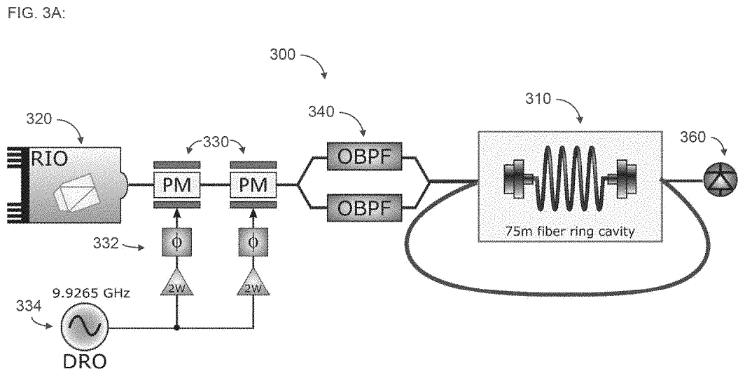

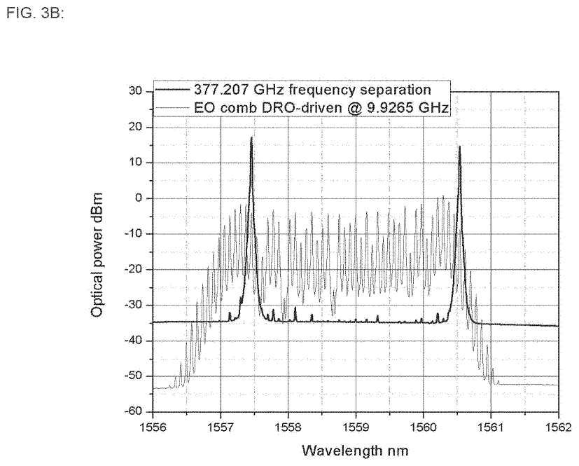

FIG. 3A schematically illustrates an example millimeter-wave oscillator 300 based on electro-optic multiplication of a microwave source spectrally purified by a fiber-ring cavity 310 (e.g., Brillouin-based fiber-ring cavity) generating two Stokes waves impinging a photosensitive element 360 in accordance with certain embodiments described herein. The example millimeter-wave oscillator 300 of FIG. 3A comprises a single CW pump laser 320 (e.g., available from Redfern Integrated Optics of Santa Clara, Calif.) that is phase modulated by two cascaded electro-optic phase modulators 330 (PM) driven by two phase shifters 332 (ϕ) and a dielectric-resonant oscillator 334 (DRO) (e.g., at around 10 GHz). In certain embodiments, the example millimeter-wave oscillator 300 of FIG. 3A is configured to generate optical sidebands on both sides of the pump signals. As schematically illustrated in FIG. 3A, the example millimeter-wave oscillator 300 further comprises two separate optical band pass filters 340 (OBPFs) configured to spectrally filter the two sidebands and to provide the spectrally filtered sideband pump signals to the fiber-ring cavity 310. The frequency difference of the OBPFs 340 can be chosen by a user. The fiber-ring cavity 310 is configured to generate the Stokes waves in response to the sideband pump signals. The example millimeter-wave oscillator 300 of certain embodiments is configured for the multiplication of the DRO 334 to the millimeter-wave domain spectrally purified by the fiber-ring cavity 310.

FIG. 3B is a plot of the optical power (dB) versus wavelength (nm) of the electro-optic frequency comb generated by the example millimeter-wave oscillator 300 of FIG. 3A, before and after spectral filtering and amplification, in accordance with certain embodiments described herein. The optical power before spectral filtering and amplification is denoted in FIG. 3A by the light line and spans nearly 5 nm, and the optical power spectrum after spectral filtering and amplification is denoted in FIG. 3B by the dark line, and shows the two optical modes that are selected through the two OBPFs 340 and an EDFA. The signal-to-noise ratios of the two optical modes are greater than 50 dB, and these two optical modes are intrinsically phase coherent and can be used to pump the fiber-ring cavity, as shown in FIG. 3A.

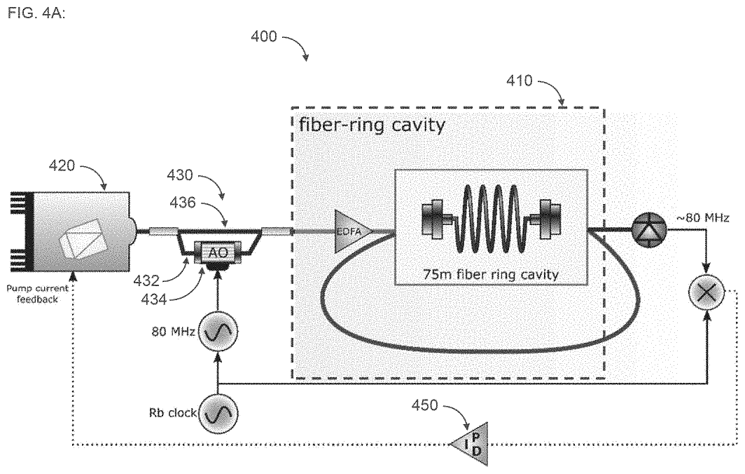

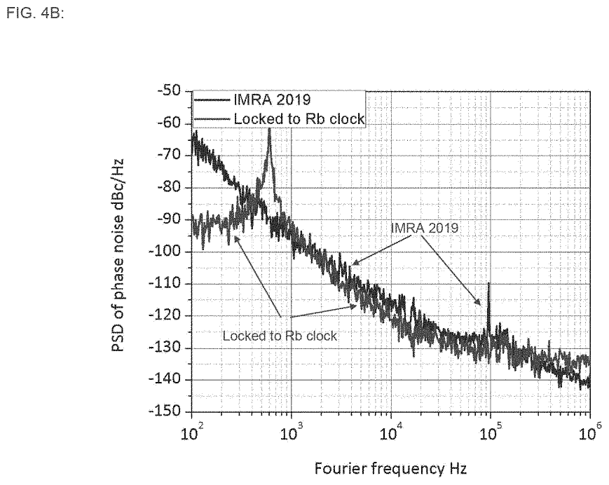

FIG. 4A schematically illustrates an example configuration 400 for the stabilization (e.g., phase lock) of a fiber-ring cavity 410 to a microwave reference in accordance with certain embodiments described herein. The configuration 400 of FIG. 4A can be useful as a robust Brillouin source in standard pressure and temperature operation. As schematically illustrated by FIG. 4A, a laser pump 420 sends pump signals through an interferometer 430 comprising a first arm 432 comprising an acousto-optic (AO) modulator 434 and a second arm 436. The output of the interferometer 430 comprises optical signals comprising two optical wavelengths separated by the frequency driving the AO modulator 434, and intrinsically is a coherent pumping of the fiber-ring cavity 410. A beatnote between the two Stokes generated signals carries the noise of the fiber-ring cavity 410 and the two oscillating modes are separated from one another in frequency only by a few tens of MHz. In certain embodiments, the beatnote can be down-converted to DC with the same signal driving the AO modulator 434 plus a frequency offset corresponding to the cavity resonances and can generate an error signal. Through a PID controller 450, this error signal can be applied to the pump current of the pump laser 420 (e.g., through a thermo-locking effect). While the example configuration 400 of FIG. 4 can be used to stabilize the fiber-ring cavity 410, it can be difficult to extract a single laser out of the example configuration 400.

FIG. 4B is a plot of the power spectral density (PSD) of the phase noise (dBc/Hz) (e.g., in-loop phase locking error) versus Fourier frequency (Hz) of an example millimeter-wave oscillator without phase locking (labeled “IMRA 2019”) and with phase locking of the Brillouin oscillator to a rubidium (Rb) clock (labeled “Locked to Rb clock”) in accordance with certain embodiments described herein. The in-loop phase locking, through the thermo-locking effect, of the fiber-ring cavity is stabilized to the Rb clock by feeding back the error signal to the pump CW laser. In certain embodiments, a feedback loop bandwidth of about 600 Hz can be used to not hinder the high-spectral purity of the Brillouin oscillation.

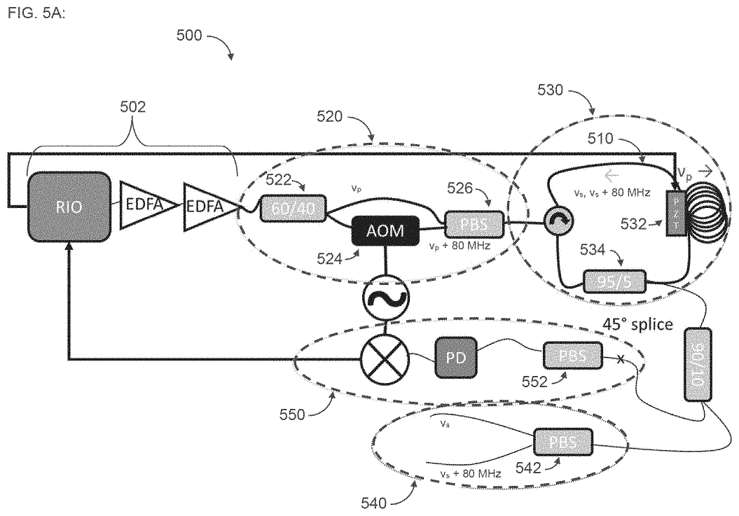

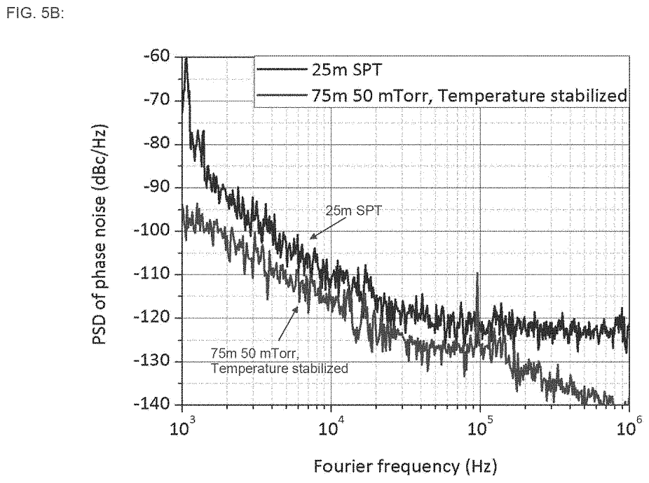

FIG. 5A schematically illustrates an example configuration 500 for the stabilization of a fiber-ring cavity 510 to a microwave reference and polarization handling for implementing a single frequency laser generator in accordance with certain embodiments described herein. In the top left oval 520 of FIG. 5A, monochromatic CW light (e.g., from source 502) is split via a 60/40 beam splitter 522, the component on the bottom arm's frequency is shifted by an rf frequency (e.g., by AO modulator 524), and in the top arm remains unchained. The two frequency components are recombined via a polarizing beam splitter (PBS) 526 and the two frequency components are transmitted on orthogonal polarization axes in the fiber. In the top right oval 530 of FIG. 5A, the two orthogonally polarized optical frequencies pump a fiber-ring cavity 510 to generate orthogonally polarized Stokes radiation separated by the AOM frequency. The lead zirconate tantalite (PZT) transducer 532 adjusts the length of the fiber cavity 510. The 95/5 beam splitter 534 outcouples the counter-clockwise propagating Brillouin light. In the bottom oval 540 of FIG. 5A, a PBS 542 is used to separate the two Stokes frequencies. In the remaining oval 550 of FIG. 5A, a PBS 552 is used to collapse the two Stokes components into a single polarization component allowing for heterodyne detection of the frequency difference. This frequency difference is then locked to the rf drive of the AOM by changing the length of the fiber-ring cavity 510 via actuation of the PZT transducer 532 or by changing the source laser (RIO) frequency. In certain embodiments, the two pump signals are orthogonally polarized and the two Stokes waves are separated and spatially split from one another by a polarization beam splitter (PBS). Birefringence of the fiber can lead to additional noise decorrelation. In certain embodiments, a single wavelength can be extracted from the example configuration 500 of FIG. 5A which can be used as a single wavelength generator having a spectral purity that is dependent on the quality factor of the fiber-ring cavity 510 and a long-term stability that is comparable to the stability of the microwave reference used for the stabilization.

FIG. 5B is a plot of the power spectral density (PSD) of the phase noise (dBc/Hz) versus Fourier frequency (Hz) of the example configuration 500 of FIG. 5A operated as a single out-of-loop continuous wave laser used in accordance with certain embodiments described herein. The optical phase noise of the out-of-loop cw laser having a 25-meter long fiber-ring cavity (labeled “25 m SPT”) is higher than the optical phase noise of the out-of-loop cw laser having a 75-meter long fiber-ring cavity (labeled “75 m 50 mTorr, Temperature stabilized”), but has a white phase noise floor of −120 dBc/Hz.

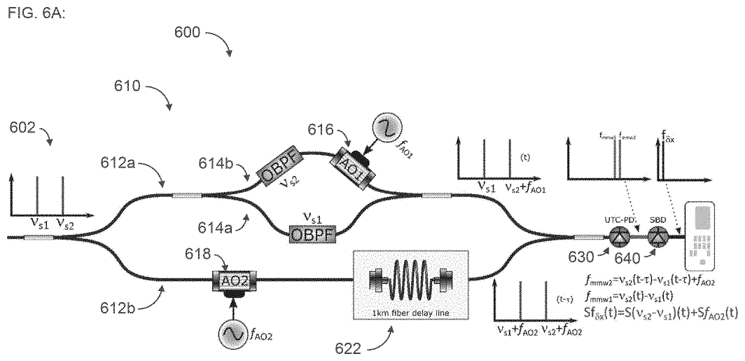

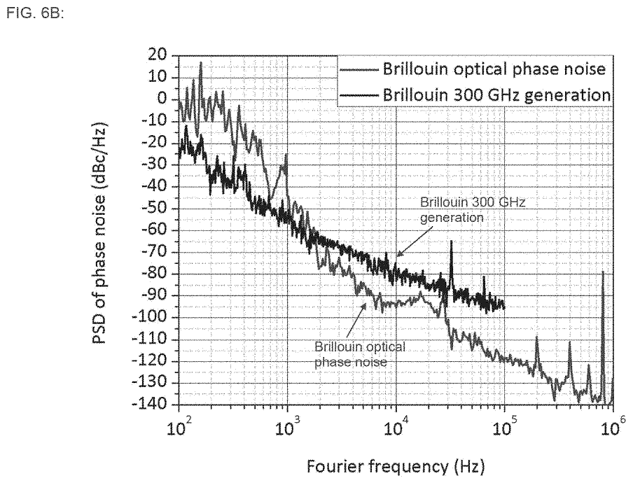

FIG. 6A schematically illustrates an example millimeter-wave phase noise analyzer 600 based on a self-heterodyne interferometer 610 and a down-conversion mechanism based on a photosensitive element coupled to a millimeter-wave amplitude detector in accordance with certain embodiments described herein. In certain embodiments, the example phase noise analyzer 600 of FIG. 6A is configured to detect, measure, and calibrate the power spectral density (PSD) of the phase noise of a photonically-generated millimeter-wave signal. The example phase noise analyzer 600 comprises a self-heterodyne interferometer 610 configured to receive an input optical signal 602 having two optical wavelengths separated in frequency from one another by a frequency difference corresponding to a millimeter-wave frequency. A first arm 612a (e.g., upper arm in FIG. 6A) of the interferometer 610 is configured to frequency-shift the input frequency difference by splitting the optical signal into two sub-arms. The first sub-arm 614a (e.g., lower sub-arm in FIG. 6A) spectrally filters one wavelength and the second sub-arm 614b (e.g., upper sub-arm in FIG. 6A) spectrally filters and frequency-shifts the other wavelength through an acousto-optic modulator (AO1) 616 driven at f_{AO1}. Both wavelengths are then recombined with their frequency difference shifted by f_{AO1}. The second arm 612b (e.g., lower arm in FIG. 6A) of the interferometer 610 is configured to frequency-shift the input optical signal 602 with an acousto-optic modulator (AO2) 618 driven at f_{AO2} so as to not interfere with the wavelengths of the first arm 612a, and comprises a fiber delay line 622 configured to delay the frequency-shift two-wavelength optical signal by a delay τ.

The example phase noise analyzer 600 further comprises a photosensitive element 630 (e.g., UTC-PD) configured to receive the four optical lines from the first and second arms 612a,b:

vₛ₁(t) (1)

[vₛ₂+f_{AO1}](t) (2)

[vₛ₁+f_{AO2}](t−τ) (3)

[vₛ₂+f_{AO2}](t−τ) (4)

which generates a four millimeter-wave signal:

[vₛ₂+f_{AO1}](t)−vₛ₁(t)=[vₛ₂−vₛ₁](t)+f_{AO1}(t) (5)

[ₛ₂+f_{AO2}](t−τ)−vₛ₁(t) (6)

[vₛ₂+f_{AO1}](t)−[vₛ₁+f_{AO2}](t−τ) (7)

[vₛ₂+f_{AO2}](t−τ)−[vₛ₁+f_{AO2}](t−τ)=[vₛ₂−vₛ₁](t−τ). (8)

The example phase noise analyzer 600 further comprises a millimeter-wave amplitude detector 640 (e.g., a single barrier diode (SBD) or Schottky diode) configured to receive the four millimeter-wave signal. Acting as a low pass filter, the detected beatnote of interest is:

[vₛ₂−vₛ₁](t)+f_{AO1}(t)−[vₛ₂−vₛ₁](t−τ) (9)

and the phase noise that f_{AO1} carries is then modulated by:

[vᵥ₂−vₛ₁](t)−[vₛ₂−vₛ₁](t−τ) (10)

which is the phase noise of interest. The radio-frequency detected at the output of the millimeter-wave amplitude detector 600 therefore contains the phase noise of the millimeter-wave oscillator under test.

FIG. 6B is a plot of the power spectral density (P SD) of the millimeter-wave phase noise (dBc/Hz) versus Fourier frequency (Hz) measured at 300 GHz using the example millimeter-wave phase noise analyzer 600 of FIG. 6A. FIG. 6B shows the fundamental limit of the example phase noise analyzer of FIG. 6A. The noise equivalent power in the millimeter-wave amplitude detector imposes a limit of 0/f² dBc/Hz.

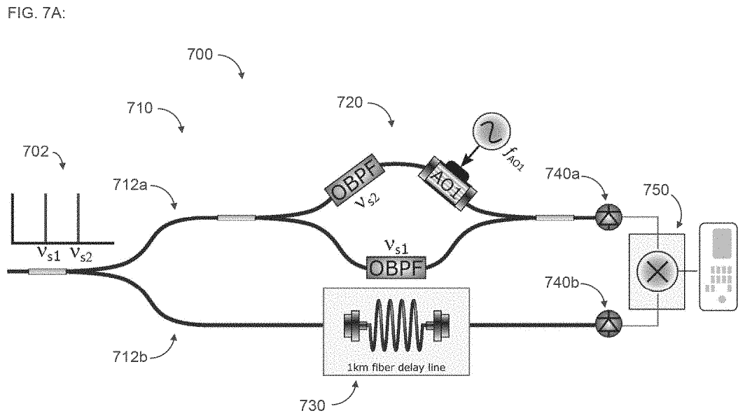

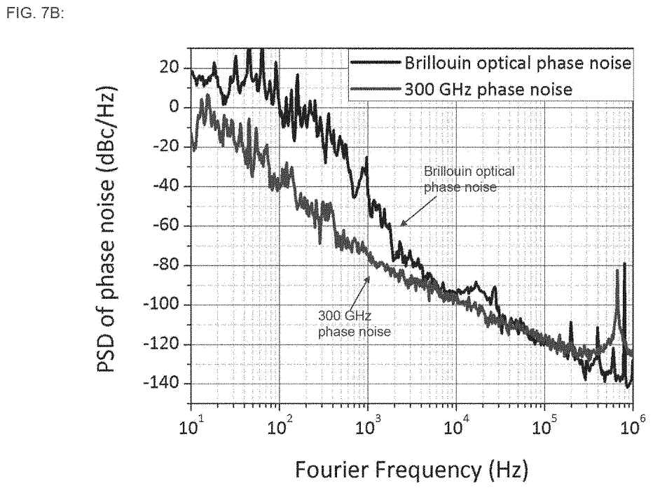

FIG. 7A schematically illustrates an example millimeter-wave phase noise analyzer 700 based on a self-heterodyne interferometer 710 and a down-conversion mechanism based on two photosensitive elements 740a,b coupled to a millimeter-wave fundamental frequency mixer 750 in accordance with certain embodiments described herein. The self-heterodyne interferometer 710 receives the input optical signal 702 having two optical wavelengths separated in frequency from one another by a frequency difference corresponding to a millimeter-wave frequency and comprises a frequency shifting interferometer 720 in a first arm 712a (e.g., upper arm in FIG. 7A) and a fiber delay line 730 in a second arm 712b (e.g., lower arm in FIG. 7A). The example phase noise analyzer 700 of FIG. 7A further comprises a first photosensitive element 740a configured to receive the output of the frequency shifting interferometer of the first arm 712a, a second photosensitive element 740b configured to receive the output of the fiber delay line 730 of the second arm 712b, and a fundamental millimeter-wave frequency mixer 750 configured to receive the outputs of the first and second photosensitive elements 740a,b. The first and second photosensitive elements 740a,b and the fundamental millimeter-wave frequency mixer 750 are configured to down convert the optical signals to the base band.

FIG. 7B is a plot of the power spectral density (P SD) of the millimeter-wave phase noise (dBc/Hz) versus Fourier frequency (Hz) of the example millimeter-wave oscillator 200 of FIG. 2A measured at 300 GHz using the example millimeter-wave phase noise analyzer 700 of FIG. 7A. The phase noise (labeled “300 GHz phase noise”) shows that at high Fourier frequency, the example millimeter-wave oscillator 200 of FIG. 2A follows the optical phase noise of the Brillouin laser (labeled “Brillouin optical phase noise”).

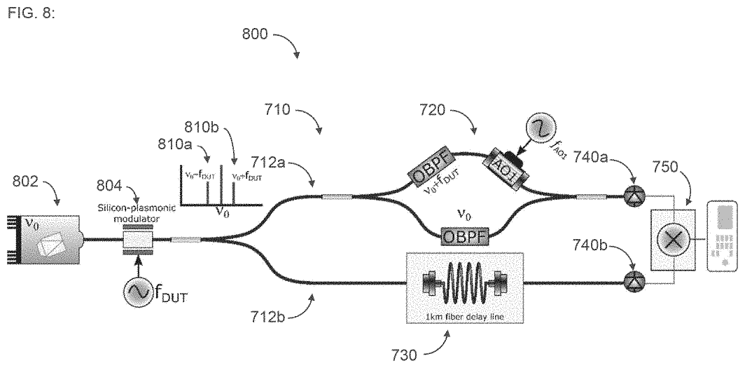

FIG. 8 schematically illustrates an example millimeter-wave phase noise analyzer 800 based on a millimeter-wave-to-optical converter, a self-heterodyne interferometer 710, and a down-conversion mechanism based on two photosensitive elements 740a,b coupled to a millimeter-wave fundamental frequency mixer 750 in accordance with certain embodiments described herein. The example millimeter-wave phase noise analyzers 600, 700 of FIGS. 6A and 7A are configured for use when the example millimeter-wave oscillator is photonically generated and contains two optical wavelengths. In certain embodiments in which the example millimeter-wave oscillator 802 only provides an electrical signal, an electrical-to-optical conversion element can be used, as schematically illustrated by FIG. 8. For example, a silicon-plasmonic electro-optic modulator 804 can have a sufficient ultra-high bandwidth to be used in the example phase noise analyzer 800 of FIG. 8. For optical signals that are modulated by the optical modulator 804 driven by the millimeter-wave signal, optical sidebands 810a,b are generated and the frequency difference between the optical sidebands 810a,b corresponds to the millimeter-wave frequency of the oscillator 802 under test. Additionally, this frequency difference also contains the phase noise of the oscillator 802. Therefore, the self-heterodyne interferometers described herein can be used to measure the phase noise of the oscillator 802 under test.

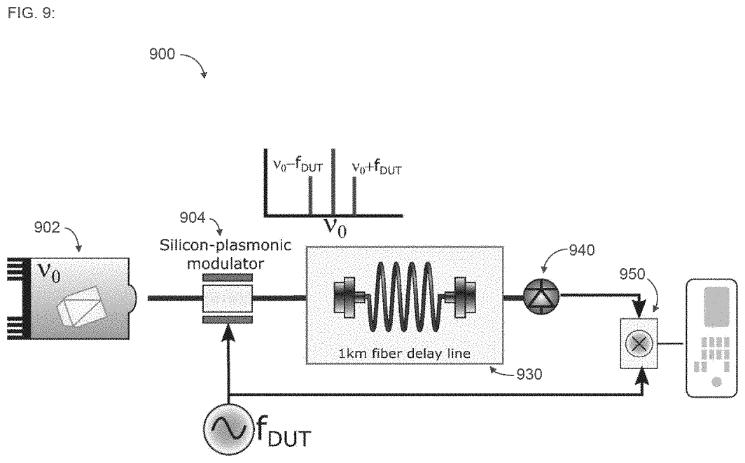

FIG. 9 schematically illustrates an example millimeter-wave phase noise analyzer 900 based on a millimeter-wave-to-optical converter, a self-homodyne interferometer, and a down-conversion mechanism based on one photosensitive element coupled to a millimeter-wave fundamental frequency mixer in accordance with certain embodiments described herein. As schematically illustrated in FIG. 9, the output of the oscillator 902 under test is split into two paths where a first path converts the millimeter-wave electrical signal into an optical signal through a silicon-plasmonic modulator 904 to experience a delay through an optical fiber 930. After experiencing the delay in the optical domain, the millimeter-wave signal is brought back in the millimeter-wave domain using a photosensitive element 940. In certain embodiments in which the frequency mixer 950 has an output which is direct current coupled, the phase noise can be retrieved at the output of the frequency mixer 950.

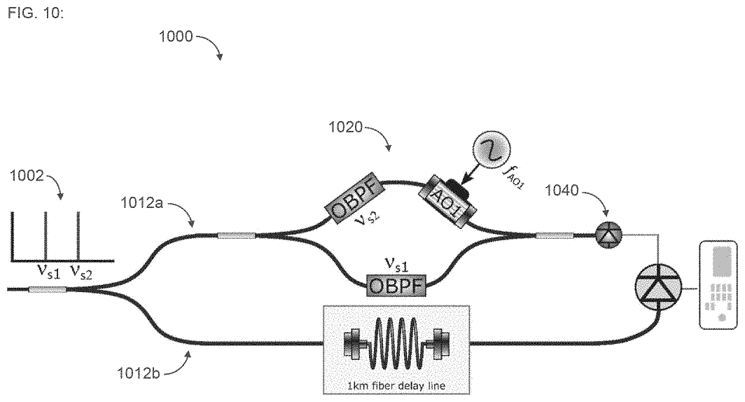

FIG. 10 schematically illustrates an example millimeter-wave phase noise analyzer 1000 based on a self-homodyne interferometer 1020 and a down-conversion mechanism based on one photosensitive element 1040 coupled to a millimeter-wave heterodyne detector in accordance with certain embodiments described herein. While near-quantum-limited heterodyne terahertz detection has so far been possible only through the use of cryogenically cooled superconducting mixers as frequency downconverters, the example millimeter-wave phase noise analyzer 1000 of FIG. 10 can exploit recent advances of room-temperature heterodyne terahertz detectors with near-quantum-limited sensitivity. This type of heterodyne detector has two inputs. A first input can receive a millimeter-wave or terahertz signal, while a second input can receive an optical signal 1002 comprising two optical wavelengths with a frequency difference in the millimeter-wave or terahertz domain. The heterodyne detector 1000 can then output the frequency difference between the first and second inputs by using a frequency-shifting element, realized in the optical domain, in a first arm (e.g., upper arm 1012a of FIG. 10). The output of the heterodyne detector 1000 is an intermediate frequency in a base band directly carrying the phase noise of the millimeter-wave oscillator under test.

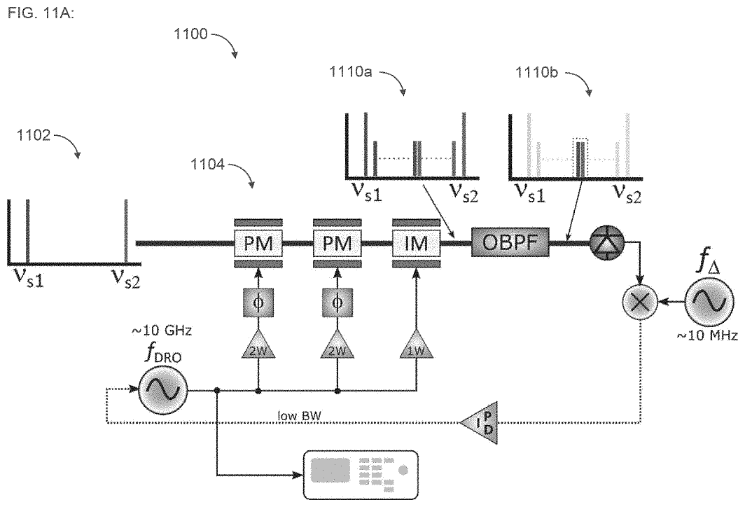

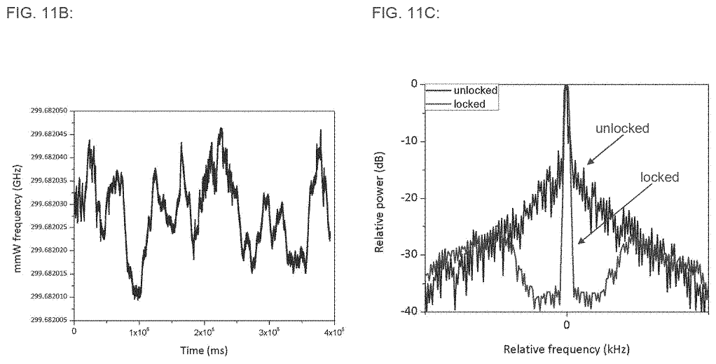

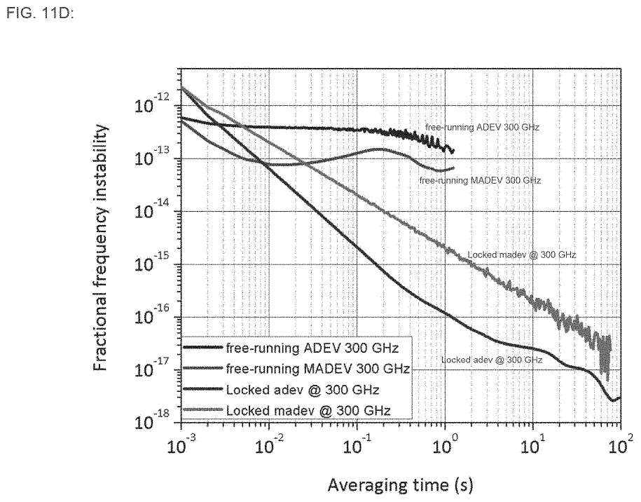

FIG. 11A schematically illustrates an example millimeter-wave frequency counter 1100 based on an electro-optic down conversion of the frequency difference of two optical wavelengths in accordance with certain embodiments described herein. Most frequency counters work by using a counter which accumulates the number of events occurring within a specific period of time. After a preset period, known as the gate time (e.g., one second), the value in the counter is transferred to a display and the counter is reset to zero. If the event being measured repeats itself with sufficient stability and the frequency is considerably lower than that of the clock oscillator being used, the resolution of the measurement can be greatly improved by measuring the time for an entire number of cycles, rather than counting the number of entire cycles observed for a pre-set duration (e.g., often referred to as the reciprocal technique). The internal oscillator providing the time signals can be referred to as the timebase and is to be accurately calibrated. Microwave frequency counters can currently measure frequencies up to almost 56 GHz, but cannot be used directly at millimeter-wave frequencies. In certain embodiments, a high frequency is down-converted with a frequency mixer and a local oscillator close in frequency to the oscillator under test. Stable local oscillators are generally not available at millimeter-wave frequencies and sub-harmonic mixers have significant conversion loss which will strongly limit the signal to noise ratio.

In certain embodiments, the example millimeter-wave frequency counter 1100 of FIG. 11A can be used to implement an optoelectronic down-conversion in order to count the millimeter-wave frequency. For example, the two optical lines 1102 (e.g., separated by a few hundreds of GHz) can be phase modulated by a phase modulator 1104 driven by a microwave reference (e.g., at 10 GHz), and two optical frequency combs 1110a,b can then be generated from the two optical lines, respectively. In certain embodiments, a low frequency detection can be performed with a photodiode of the beatnote between the two optical frequency combs 1110a,b. This beatnote will carry the instability of the millimeter-wave signal. In certain embodiments, a phase locked loop is used to stabilize the microwave reference and the frequency is counted with respect to a frequency standard, with the millimeter-wave frequency read using: f_{mmW}=2n×f_{RF}+f_{IF}.

FIG. 11B is a plot of the millimeter-wave frequency (GHz) versus time (ms) of an example frequency counted millimeter-wave oscillator 200 (e.g., as shown in FIG. 2A) in accordance with certain embodiments described herein. The instantaneous frequency was measured using the example frequency counter 1100 of FIG. 11A. FIG. 11C is a plot of the relative power (dB) versus relative frequency (kHz) of the phase locking for internal counting of the example millimeter-wave oscillator 200 of FIG. 2A using the example frequency counter 1100 of FIG. 11A in accordance with certain embodiments described herein. FIG. 11C shows that is feasible to phase lock the example millimeter-wave oscillator 200 of FIG. 2A to a microwave reference, a microwave atomic clock, or a Global Positioning System (GPS) disciplined microwave oscillator (e.g., with a locking bandwidth of a few tens of kHz) by using the example frequency counter 1100 of FIG. 11A.

FIG. 11D is a plot of the fractional frequency instability versus averaging time (s) exhibiting the sensitivity and resolution of the example millimeter-wave frequency counter of FIG. 11A. FIG. 11D shows the absolute limit of the example millimeter-wave frequency counter 1100 of FIG. 11A. At 300 GHz, the example frequency counter 1100 of FIG. 11A has a fractional frequency instability of 2×10⁻¹⁵/τ, in terms of Allan deviation (labeled “Locked madev@300 GHz”) and an instability level of 1×10⁻¹⁶ at one second averaging time, in terms of modified Allan deviation (labeled “Locked adev@300 GHz”), suggesting that the example millimeter-wave oscillator of FIG. 2A can be locked or can be counted with the stability of an optical lattice clock.

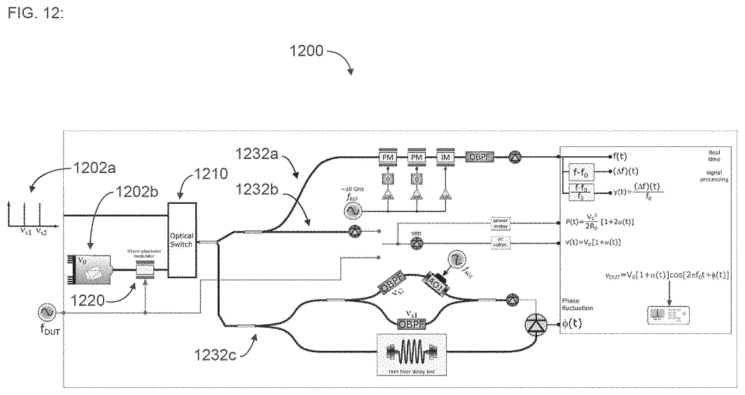

FIG. 12 schematically illustrates an example millimeter-wave spectrum analyzer 1200 having ultra-high sensitivity in accordance with certain embodiments described herein. In certain embodiments, data sets of three quantities can be used (e.g., measured in real-time) to plot the electrical spectrum of an electromagnetic wave v(t): the instantaneous frequency f(t), the phase modulation ϕ(t) and the amplitude modulation α(t) using the following equation:

v(t)=A0[1+α(t)]×cos[2πf(t)+ϕ(t)]. (11)

In certain embodiments, as schematically illustrated by FIG. 12, the spectrum analyzer 1200 is configured to receive two alternative inputs. The example spectrum analyzer 1200 can receive a first input 1202a comprising two optical signals with different frequencies with a frequency difference that is in the millimeter-wave domain and/or a second input 1202b comprising a directly generated millimeter-wave signal. In certain such embodiments, the example spectrum analyzer 1200 can comprise an optical switch 1210 configured to select either the first input 1202a or the second input 1202b. As the quantities measured are in the optical domain, the example spectrum analyzer 1200 can comprise a silicon-plasmonic modulator 1220 configured to receive and convert the millimeter-wave signal into the optical domain and to provide the converted signal to the optical switch 1210.

As schematically illustrated in FIG. 12, the example spectrum analyzer 1200 is configured to split the optical signal from the optical switch 1210 into three arms. A first arm 1232a (e.g., the upper arm of FIG. 12) measures the instantaneous frequency f(t), a second arm 1232b (e.g., the middle arm of FIG. 12) measures the amplitude modulation α(t) (e.g., using an amplitude detector, such as a Schottky diode, followed by a voltmeter with high sensitivity to measure the voltage v(t) and a millimeter-wave power meter to measure the absolute power P(t)). A third arm 1232c (e.g., the lower arm of FIG. 12) measures the phase noise ϕ(t) in real-time (e.g., using a self-heterodyne interferometer in accordance with certain embodiments described herein). In certain embodiments, the quantities measured by the first, second, and third arms 1232a,b,c are processed by a computer (e.g., a digital signal processor; a field-programmable gate array integrated circuit).

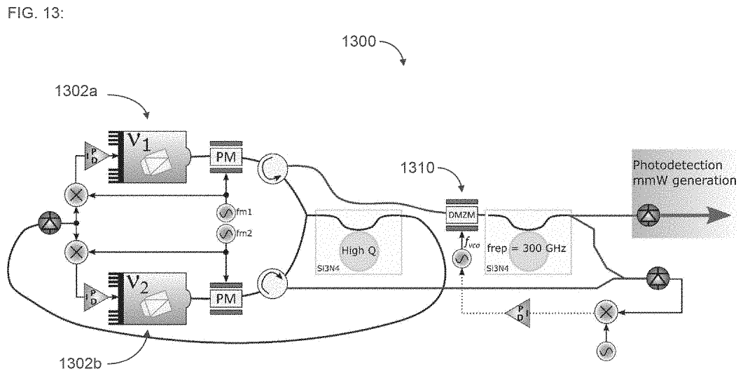

FIG. 13 schematically illustrates an example chip-scale implementation of a millimeter-wave oscillator 1300 in accordance with certain embodiments described herein. The example oscillator 1300 of FIG. 13 is configured to utilize optical frequency division of the differential phase noise of two optical waves from first and second CW lasers 1302a,b at frequencies v₁ and v₂ separated by a few THz. The first and second CW lasers 1302a,b can be stabilized (e.g., using Pound-Drever-Hall stabilization) to a common resonator with a high quality factor. In certain embodiments, the first and second CW lasers 1302a,b fractionally follow the fluctuations of the common resonator, which can lead to common noise rejection to the first order. The two backscattered Stokes oscillations can be extracted for better spectral purity. In certain embodiments, a Dual-Mach-Zehnder-Modulator (DMZM) 1310 is configured (e.g., acting as two actuators) to control of the repetition rate frequency fᵣₑₚ and the carrier envelop offset frequency f_{ceo} and to generate an optical frequency microcomb that is being pumped by the first CW laser 1302a at a mode resonance n. Each optical comb mode frequency noise can be derived from the frequency noise of the first CW laser 1302a. In certain embodiments, a beatnote between the second CW laser 1302b and an adjacent comb mode m is compared with a stable RF signal in baseband. The frequency comparison can be used to generate an error signal that is fed back to the DMZM 1310 modulating repetition rate frequency fᵣₑₚ or the carrier envelop offset frequency f_{ceo}.

In certain embodiments, the optical frequency microcomb phase noise is determined using two equations:

nδfᵣₑₚ+δf_{ceo}=δv₂ (12)

mδfᵣₑₚ+δf_{ceo}=δv₂ (13)

leading to:

δfᵣₑₚ=(δᵥ₂−δᵥ₂)/(m−n). (14)

In certain embodiments, the differential phase noise is divided down through a soliton microcomb at the repetition rate, which can be at a few hundreds of GHz (e.g., millimeter-wave). In certain embodiments, all the components schematically illustrated in FIG. 13 are chip-scale. Prediction of the phase noise performance can be difficult, and CW lasers in a chip-scale factor may not be as low noise as the bulky Brillouin source. However, using a 8 THz frequency separation down to 300 GHz, certain embodiments described herein are expected to lead to a phase noise reduction of almost 30 dB.

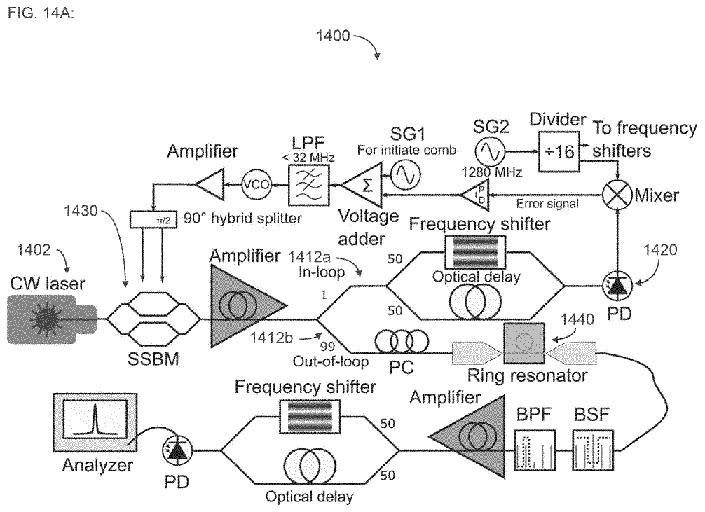

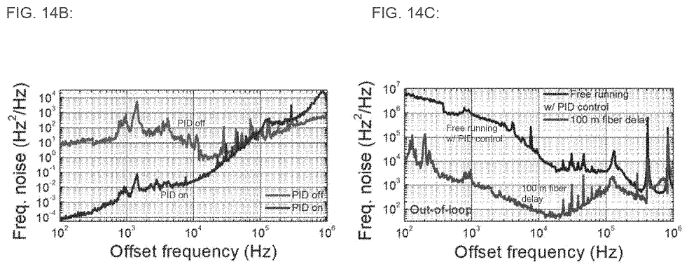

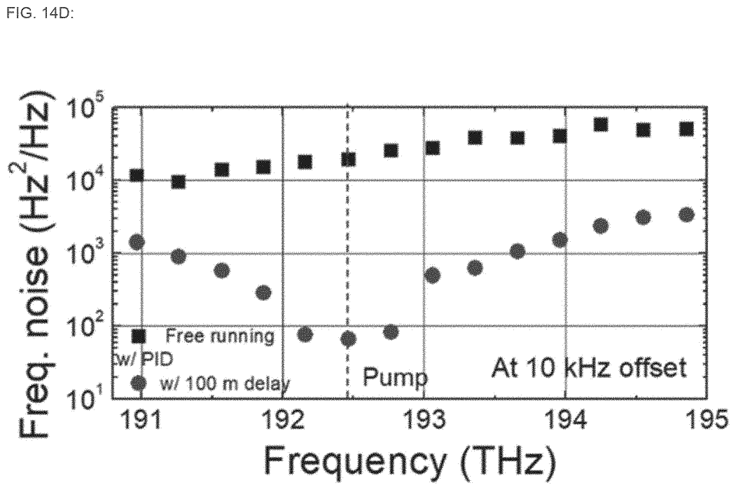

FIG. 14A schematically illustrates an example chip-scale implementation 1400 of noise reduction of an optical frequency microcomb based on the noise compensation of the pump laser in accordance with certain embodiments described herein. As schematically illustrated by FIG. 14A, pump light from a continuous-wave laser 1402 is amplified and split into two portions propagating in separate paths. A first portion of the pump light (e.g., 1% of the pump light) is received by a first arm 1412a comprising a self-heterodyne interferometer with an optical delay (e.g., delay length can be as short as a few centimeters) on a first branch and an optical frequency shifter (e.g., a single side band modulator or an acoustic optical modulator (AOM)) on a second branch, and the output signal comprising the combined output from the first and second branches is detected with a photodiode (PD) 1420. In certain embodiments, an error signal is generated by mixing the signal from the PD 1420 and a 80 MHz signal generated with a signal generator (SG2) and a divider, which can provide driving signals for all optical frequency shifters in the system. As schematically illustrated by FIG. 14A, the error signal can be received by a PID lockbox (e.g., to compensate the frequency noise of the pump), and its output control signal can be applied to a single side band modulator (SSBM) 1430 to compensate the laser noise through a voltage adder, a voltage controlled oscillator (VCO), a RF amplifier, and a 90 degree hybrid splitter.

A second portion of the pump light (e.g., 99% of the pump light) of FIG. 14A is received by a second arm 1412b comprising a ring resonator 1440 used for comb generation and for phase noise out-of-loop characterization. The soliton comb can be initiated by a fast sweep of the pump frequency with the SSBM 1430, where the sweep is launched by a step waveform from a signal generator (SG1). For example, the resonator 1440 can be made of silicon nitride and can have a free spectral range of about 300 GHz. In certain embodiments, to demonstrate the out-of-loop measurement, the strong pump light of the soliton comb is suppressed with a band stop filter (BSF) to avoid cross-talk, and one of the comb lines is chosen with a band pass filter (BPF) to measure the frequency noise. The selected comb line can be amplified and its noise characterized by a self-heterodyne interferometer frequency noise measurement.

FIG. 14B is a plot of the in-loop frequency noise of the example chip-scale implementation 1400 of FIG. 14A. As shown in FIG. 14B, most of the observed noise is suppressed by turning the PID control of the SSBM 1430 on, at offset frequencies higher than 100 kHz, noise suppression is not observed due to a limited feedback bandwidth. FIG. 14C is a plot of the frequency noise of a comb line obtained through the out-of-loop measurement of the example chip-scale implementation 1400 of FIG. 14A. As shown in FIG. 14C, a large frequency noise reduction (e.g., by nearly two orders of magnitude) is achieved at Fourier frequencies between 1 kHz and 50 kHz with the PID control. FIG. 14D is a plot of such measurements repeated for different comb lines between 1542 nm and 1568 nm (191.3 to 194.5 THz) and recorded frequency noise level at 10 kHz Fourier frequency. FIG. 14D shows a moderate increase of the comb line noise as the frequency increases for the free running condition. A local minimum is shown at a pump frequency for the PID control with 100 m delay, where the pump phase noise is suppressed, implying that the low noise of a pump is not transferred to all comb lines when repetition rate noise is large as compared to the pump noise.

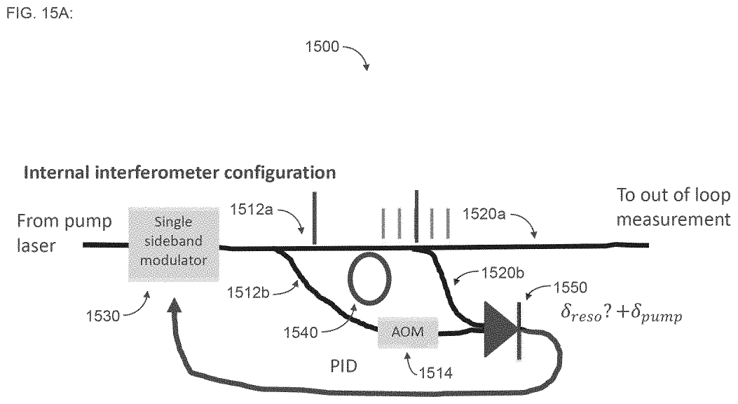

FIGS. 15A and 15B schematically illustrate two example interferometers 1500 for laser noise compensation (e.g., as used in the example implementation of FIG. 14A) in accordance with certain embodiments described herein. In each of FIGS. 15A and 15B, a microcomb is initiated by a fast sweep of frequency of a pump laser with a SSBM 1530 coupled with a ring resonator 1540. The pump light is split into two arms after the SSBM. In an internal interferometer configuration schematically illustrated by FIG. 15A, the first arm 1512a is configured to generate the microcomb and the second arm 1512b is configured to modulate the received light with an acoustic optical modulator (AOM) 1514. The microcomb generated in the first arm 1512a is split into two sub-arms, a first sub-arm 1520a configured for out of loop measurement, and a second sub-arm 1520b configured for combining its light with the modulated light of the second arm 1512b. The combined light is detected with a photodiode (PD) 1550 to measure both resonator noise and laser noise.

In an external interferometer configuration schematically illustrated by FIG. 15B, the first arm 1512a is configured to generate the microcomb and for the out of loop measurement, and the second arm 1512b is directly connected to a self-heterodyne frequency noise measurement system in an external interferometer configuration, where only laser noise is detected at a PD 1550. The detected noise can be used to generate error signals and the noise can be compensated through PID control to the SSBM 1530.

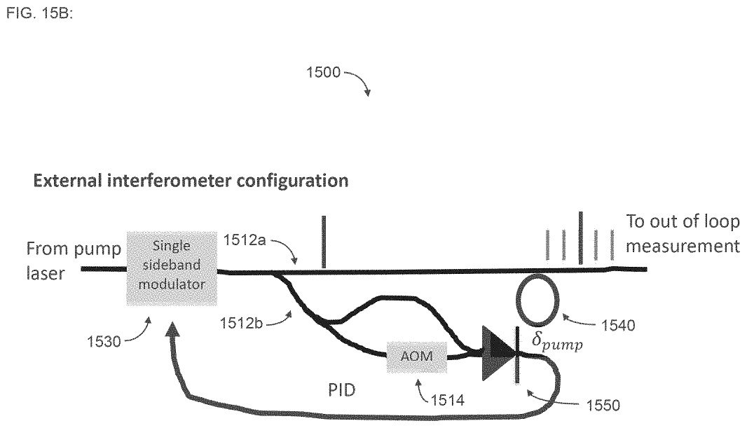

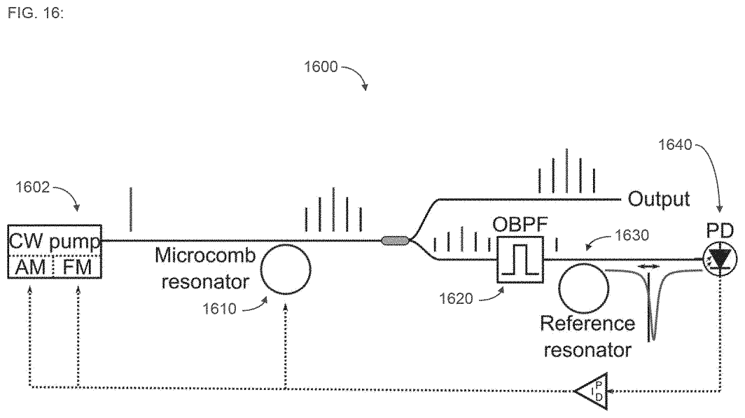

FIG. 16 schematically illustrates an example chip-scale implementation 1600 of noise reduction of an optical frequency microcomb based on the stabilization of one microcomb mode to the resonance of a microresonator 1610 in accordance with certain embodiments described herein. As schematically illustrated by FIG. 16, the microcomb is generated using a low noise source 1602 of pump light. One of the comb lines, having a frequency far away from that of the pump, is filtered out with an optical coupler and an optical band pass filter (OBPF) 1620. The filtered comb line is coupled with a reference resonator 1630, and the transmittance is measured with a photodetector (PD) 1640. The difference between the wavelength of the comb line and the resonator's resonance is measured by the transmittance of the resonator and can nominally be set a point of high transmission versus wavelength slope. The transmittance can be kept constant by controlling either the frequency of the microcomb resonator (e.g., with a heater) or the pump amplitude or frequency. In certain such embodiments, two frequencies of the microcomb with large frequency difference are stabilized, resulting in stabilization of the microcomb repetition rate.

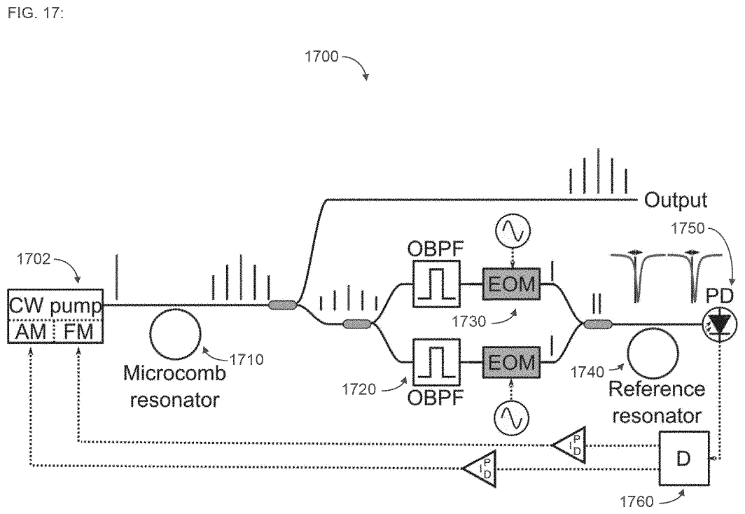

FIG. 17 schematically illustrates an example chip-scale implementation 1700 of noise reduction of an optical frequency microcomb based on the stabilization of two microcomb modes to the resonances of a microresonator in accordance with certain embodiments described herein. As schematically illustrated by FIG. 17, the microcomb is generated using a source 1702 of CW pump light and the two comb lines are filtered out with optical couplers and optical band pass filters (OBPF) 1720. The filtered comb lines are modulated with different frequencies by electro-optical modulators (EOMs) 1730, and are coupled with a reference resonator 1740, where the wavelengths of the comb lines can be set at steep slopes of the resonances. The transmittance is detected with a photodetector (PD) 1750 and a diplexer 1760 separates RF signals with the two different frequencies. Each RF signal intensity can be kept constant by controlling either the pump amplitude or frequency. In certain such embodiments, two frequencies of the microcomb with large frequency difference are stabilized, resulting in stabilization of the microcomb repetition rate.

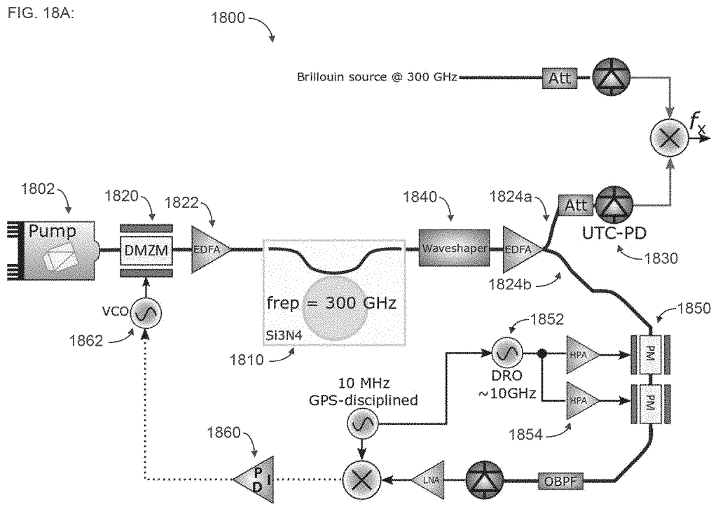

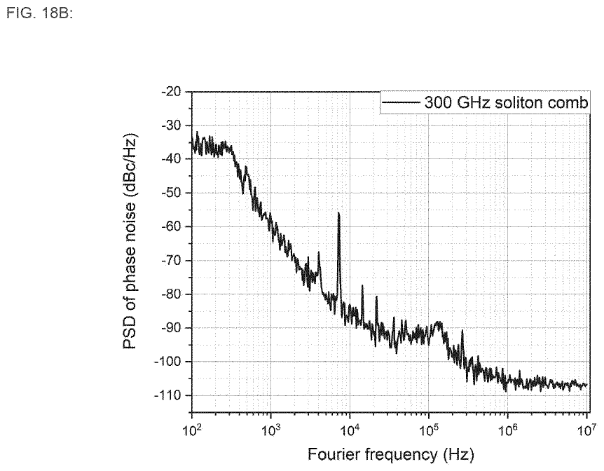

FIG. 18A schematically illustrates an example millimeter-wave oscillator 1800 (e.g., chip-scale) using an example stabilization scheme to faithfully transfer the spectral purity of a dielectric resonant oscillator to the repetition rate of a micro-resonator in a soliton regime in accordance with certain embodiments described herein. A tunable continuous-wave laser 1802 (e.g., pump laser) is configured to pump a silicon nitride (SiN₄) micro-resonator 1810 through an optical single side-band modulator 1820 (e.g., a Dual Mach-Zehnder Modulator or DMZM) and an optical amplifier 1822 (e.g., an Erbium Doped Fiber Amplifier or EDFA). The output from the optical amplifier 1822 is split into a first arm 1824a and a second arm 1824b. The first arm 1824a comprises a photosensitive element 1830 configured to photodetect the repetition rate. The second arm 1824b comprises a waveshaper 1840 configured to select two optical lines of the soliton comb (e.g., to act as a double bandpass filter). The two selected optical lines are separated in frequency by the repetition rate (e.g., in the millimeter-wave and terahertz range) and are both modulated by two cascaded phase modulators (PM) 1850 driven by a dielectric resonant oscillator (DRO) 1852 amplified with high power amplifier (HPA) 1854. The DRO 1852 can be synchronized to a 10 MHz derived signal (e.g., by an atomic clock or by GPS). Two electro-optic frequency combs are then generated from the two selected optical lines. By detecting the spectral region where the two electro-optic frequency combs overlap, an RF frequency (e.g., greater than 5 GHz when the DRO frequency is 10 GHz) can be detected. This RF frequency carries the repetition rate noise, as well as the phase noise of the DRO 1852 multiplied up by fᵣₑₚ/f_{DRO}. After RF amplification of the signal with a low noise amplifier (LNA), an error signal is generated with a phase detector where the RF frequency is mixed with the same 10 MHz signal that is synchronizing the DRO 1852. The error signal is applied to the DMZM 1820 through a PID filter 1860 driving a voltage controlled oscillator (VCO) 1862. The phase noise of the repetition rate is a copy of the phase noise of the DRO multiplied up by fᵣₑₚ/f_{DRO}.

FIG. 18B is a plot of the measured power spectral density (PSD) of the phase noise (dBc/Hz) versus Fourier frequency (Hz) of the example millimeter-wave oscillator 1800 of FIG. 18A generated with a microcomb at 300 GHz in accordance with certain embodiments described herein. To perform an out-of-loop measure of the phase noise generated with the microcomb by the millimeter-wave signal, a Brillouin source at 300 GHz was used as a reference. The Brillouin source at 300 GHz had previously been characterized with great caution preliminarily to be certain of the noise of the microcomb. A millimeter-wave fundamental frequency mixer was used to detect a beatnote between the two millimeter-wave sources. As shown in FIG. 18B, the measured phase noise reached −88 dBc/Hz at 10 kHz Fourier frequency, which is a record phase noise at 300 GHz generated by a micro-resonator.

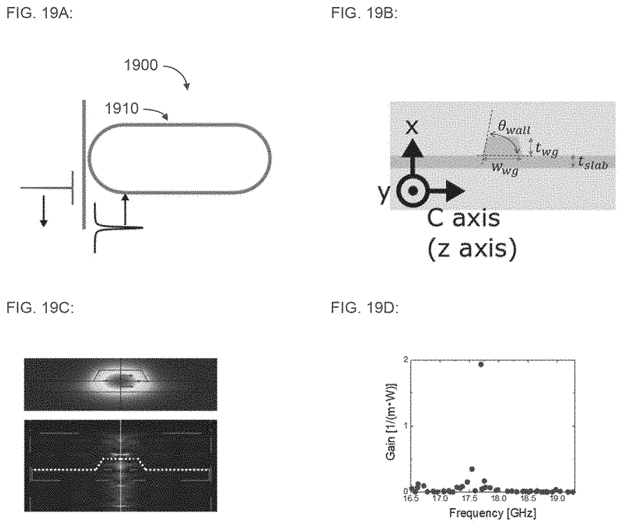

FIG. 19A schematically illustrates an example on-chip Brillouin laser 1900 based on a lithium niobate (LN) optical resonator 1910 in accordance with certain embodiments described herein. Continuous wave light is coupled with the LN resonator 1910 and the light is backscattered through Brillouin scattering. The linewidth of the backscattered light is reduced due to the optical high Q of the resonator 1910 and the acoustic damping. With a strong pump light inside the resonator 1910, an acoustic wave can be induced by the electrostriction effect or by radiation pressure in the material, and the pump light can generate a Stokes light signal scattered by the acoustic wave (e.g., in the opposite direction). The phenomenon is known as stimulated Brillouin scattering. When the free spectral range of the resonator 1910 is within a Brillouin shift frequency of LN with a certain linewidth (e.g., 17.8 GHz with a linewidth of 10-100 MHz), both the pump and the Stokes light can be on resonant with the resonator 1910, such that the system can be considered as a three level system with a certain Brillouin lasing threshold. With a high Q of the resonator 1910, the pump and the Stokes light can enhance the acoustic wave strongly and the Brillouin lasing threshold can be reduced dramatically (e.g. an estimated threshold for a LN resonator is about 20 mW with Q of 4×10⁶). In addition, the linewidth of the Stokes wave can be reduced (e.g., the frequency noise is reduced) due to the optical high Q and the acoustic damping effect (e.g., about 30 times reduction for a LN resonator with Q of 4×10⁶).

In certain embodiments, LN is used because of its moderately high photo elastic coefficients. On the other hand, LN is an anisotropic material with a trigonal crystal system, and its Brillouin shift frequency is different for different propagation directions. In certain embodiments, as schematically illustrated in FIG. 19A, the resonator structure has the form of a racetrack comprising curved waveguide portions and straight waveguide portions. In certain embodiments, the straight portions are longer than are the curved portions, and the straight portions are aligned to a crystal orientation with a higher photo elastic coefficient to maximize the Brillouin gain. In certain embodiments, the example Brillouin laser can be used to suppress frequency noise of continuous wave lasers for the chip-scale millimeter-wave source.

In certain embodiments, the properties of the Brillouin laser depend on the crystal orientation of the LN due to the anisotropic structure of LN. The properties can be estimated by simulating optical and acoustic modes excited in a waveguide. For example, Brillouin gain and shift frequency can be calculated by following the procedure described in Wenjun Qiu, Peter T. Rakich, Heedeuk Shin, Hui Dong, Marin Soljačić, and Zheng Wang, “Stimulated Brillouin scattering in nanoscale silicon step-index waveguides: a general framework of selection rules and calculating SBS gain,” Optics Express 21, 31402-419 (2013).

FIG. 19B schematically illustrates a cross section of an example LN rib waveguide structure for the Brillouin lasing of FIG. 19A in accordance with certain embodiments described herein. An x-cut LN can be employed and the whole structure can be cladded with silica. For example, as schematically illustrated in FIG. 19B, the LN rib waveguide structure can have a slab thickness t_{slab} of 0.3 micron, a waveguide width w_{wg} of 1.6 microns, a waveguide thickness t_{wg} of 0.3 micron, and a waveguide wall angle θ_{wall} of 62 degrees.

FIG. 19C depicts example simulated optical modes (upper portion of FIG. 19C) and acoustic modes (bottom portion of FIG. 19C) of the example LN waveguide with a cross section schematically illustrated in FIG. 19B in accordance with certain embodiments described herein. The simulation was performed by the finite element method.

FIG. 19D is a plot of the Brillouin shift frequency versus calculated Brillouin gain in an example x-cut LN waveguide in accordance with certain embodiments described herein. As shown in FIG. 19D, the obtained maximum gain and its Brillouin shift frequency for a pump light with wavelength of 1.55 microns were about 1.9 (m*W)⁻¹ and 17.7 GHz, respectively. The same calculation was performed for LN waveguides with different crystal orientations, and a maximum gain of about 0.45 (m*W)⁻¹ and a Brillouin shift frequency of 17.7 GHz were obtained for z-cut LN (e.g., y axis corresponding to the horizontal axis in a waveguide cross section), and a maximum gain of about 0.48 (m*W)⁻¹ and a Brillouin shift frequency of 19.7 GHz were obtained for y-cut LN (e.g., x axis corresponding to the horizontal axis in a waveguide cross section), respectively.

Thus, the invention has been described in several embodiments. It is to be understood that the embodiments are not mutually exclusive, and elements described in connection with one embodiment may be combined with, rearranged, or eliminated from, other embodiments in suitable ways to accomplish desired design objectives. No single feature or group of features is necessary or required for each embodiment.

For purposes of summarizing the present invention, certain aspects, advantages and novel features of the present invention are described herein. It is to be understood, however, that not necessarily all such advantages may be achieved in accordance with any particular embodiment. Thus, the present invention may be embodied or carried out in a manner that achieves one or more advantages without necessarily achieving other advantages as may be taught or suggested herein.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

1. A method of generating millimeter-wave optical signals, the method comprising:
phase locking two frequency components of a bichromatic pump source;
inputting the two frequency components into a fiber-ring cavity and generating a bichromatic output from the fiber-ring cavity; and
photomixing the bichromatic output of the fiber-ring cavity.

2. The method of claim 1, wherein the bichromatic pump source comprises a single laser, an electro-optic comb, and at least one optical bandpass filter.

3. The method of claim 1, wherein the fiber-ring cavity has a mode spectrum that is phase locked to a microwave reference frequency.

4. The method of claim 3, wherein the fiber-ring cavity is pumped by the two frequency components of the bichromatic pump source, the two frequency components having a first frequency and a second frequency separated from the first frequency by the microwave reference frequency or by an integer multiple of the microwave reference frequency.

5. The method of claim 3, further comprising comparing a phase of a heterodyne beat between the two frequency components to a phase of the heterodyne beat between the two frequency components.

6. The method of claim 5, wherein the two frequency components are phase locked by adjusting the fiber length using a mechanical fiber stretcher, adjusting a fiber temperature, and/or adjusting a frequency of the pump light.

7. The method of claim 3, further comprising separating the two frequency components using polarization splitting.

8. The method of claim 7, wherein the two frequency components have orthogonal polarization axes.

9. A phase noise analyzer configured to measure phase noise of millimeter-wave radiation, the phase noise analyzer comprising:
an optical interferometer comprising:
a first arm configured to propagate two first optical signals separated in frequency from one another by a millimeter wave frequency; and
a second arm configured to propagate two second optical signals separated in frequency from one another by a sum or a difference of the millimeter wave frequency and a radio frequency; and
an optical path configured to propagate a delayed heterodyne signal indicative of a frequency difference of the two first optical signals and the two second optical signals.

10. The phase noise analyzer of claim 9, further comprising a photosensitive element and a millimeter-wave amplitude detector configured to generate and detect the delayed heterodyne signal.

11. The phase noise analyzer of claim 9, further comprising two photosensitive elements and a millimeter-wave amplitude fundamental mixer configured to generate and detect the delayed heterodyne signal.

12. The phase noise analyzer of claim 9, further comprising a photosensitive element and a heterodyne Terahertz detector configured to generate the delayed heterodyne signal.

13. A phase noise analyzer configured to measure phase noise of millimeter wave radiation, the phase noise analyzer comprising:
an optical frequency modulator configured to be driven by the millimeter wave radiation, to receive a continuous wave laser signal, and to generate optical sidebands on the continuous wave laser signal, the optical sidebands spaced from the continuous wave laser signal by a spacing equal to the millimeter wave radiation;
an optical delay line; and
a photoconductive element and a mixer configured to derive a homodyne beat between a frequency difference between the optical sidebands and the millimeter wave radiation.

14. A dual mode spectrum analyzer configured to analyze millimeter wave radiation phase noise, the dual mode spectrum analyzer comprising:
an optical switch configured to select an optical input from either bichromatic radiation or CW laser radiation that is modulated at a millimeter wave frequency of the millimeter wave radiation;
a phase noise analyzer as described in claim 13;
a frequency detector;
a photosensitive element configured to photomix the bichromatic radiation;
a millimeter-wave power detector; and
a millimeter-wave voltage detector.

15. A method for real-time frequency counting millimeter-wave frequencies and Terahertz frequencies generated from photomixing of two optical frequencies, the method comprising:
generating spatially overlapped interleaving electro-optic combs from each of the two optical frequencies using frequency and amplitude modulators; and
optical and electronic filtering of the two interleaved combs to isolate the lowest difference frequency between the two interleaved combs at an electronically countable radio frequency.

16. A chip-scale millimeter-wave source with reduced phase noise, the source comprising:
a photonic integrated frequency comb having a repetition frequency or a multiple of the repetition frequency that is tunable to the millimeter wave frequency;
means for phase locking two comb teeth to two optical frequencies by adjusting the repetition frequency and carrier offset frequencies of the frequency comb;
means for reducing phase noise of the resulting millimeter wave relative to a phase noise of the two optical frequencies.

17. The chip-scale millimeter-wave source of claim 16, wherein the two optical frequencies are locked to the same stable frequency discriminator.

18.-22. (canceled)
